(19) United States
(12) Patent Application Publication
(10) Pub. No.: US 2022/0305502 A1
(43) Pub. Date: Sep. 29, 2022

(54) FLOW-FOCUSING SEED TREATMENT DEVICE AND METHODS

(71) Applicant: Zyxogen, LLC, Fort Lauderdale, FL (US)

(72) Inventor: Jeff Badovick, Ormond Beach, FL (US)

(21) Appl. No.: 17/656,992

(22) Filed: Mar. 29, 2022

Related U.S. Application Data
(60) Provisional application No. 63/167,473, filed on Mar. 29, 2021.

(51) Int. Cl. B05B 1/20; B05B 7/04

(52) U.S. Cl. CPC B05B 1/205; B05B 7/0416; A01C 1/06

(57) ABSTRACT

A liquid flow-focusing apparatus for droplet atomization may include a dispensing body, including a liquid duct and a gas duct defined therein. The apparatus may include a plurality of nozzle wells defined in the dispensing body. The apparatus may include a plurality of flow-focusing nozzle inserts. Each nozzle well of the plurality of nozzle wells may be shaped to house a flow-focusing nozzle insert of the plurality of flow-focusing nozzle inserts. Each flow-focusing nozzle insert of the plurality of flow-focusing nozzle inserts may be housed in a corresponding nozzle well of the plurality of nozzle wells. Each flow-focusing nozzle insert of the plurality of flow-focusing nozzle inserts may be in fluid communication with the liquid duct and the gas duct.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims priority to U.S. Provisional Patent Application No. 63/167,473, entitled “FLOW FOCUSING SEED TREATMENT DEVICE AND METHODS,” filed on Mar. 29, 2021, which is pending, and is incorporated by reference in its entirety.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND

The present disclosure generally relates to nozzle devices and methods for creating atomized sprays to provide greater coverage in dispensing liquids. More particularly, the present disclosure relates to a multi-orifice nozzle and associated components for droplet atomization.

Devices for dispensing liquids may be used in a variety of settings. One such setting includes the treatment of seeds with chemical agents, such as antimicrobials, fungicides, insecticides, coloring agents, fertilizer, growth promoters, etc. Conventional devices introduce a chemical agent to the seeds while the seeds are being agitated in order to provide greater coverage of the chemical agent across the seeds. A portion of the seeds are directly exposed to the chemical agent. This may occur by direct contact when the chemical agent is dispensed from a source (such as by manual introduction or through a hose). As the seeds are agitated, the remaining seeds may be indirectly exposed to the chemical agent. The chemical agent may transfer from seed to seed or from the container which has excess chemical agents until all of the seeds have been exposed to the chemical agent.

Conventional methods of agitating seeds until the chemical agent is spread across the entire load of seeds can be inefficient and ineffective at properly treating a batch of seeds. For example, the seeds may be disproportionately treated with the chemical agent, leaving some seeds effectively untreated and other seeds overtreated. Further, the agitation process may damage some of the seeds if the process occurs for too long or if the agitation is too rough in order to achieve ubiquitous and even coverage. Thus, these methods may necessitate a balance between treatment coverage and maintaining the integrity of the seed. Seed treaters may also find this problem particularly difficult when high volumes of seeds are to be treated. On an industrial scale, the balance between effective coverage and efficient processes with high yield is crucial.

Another difficulty associated with dispensing chemical agents onto seeds includes the varying viscosities and densities of the variety of chemicals used. Certain chemicals may be prone to clogging liquid feeders where others may be prone to fast and uncontrolled dispensing and dispersion.

What is needed then are improvements in liquid dispensers, nozzles, and methods for delivery of liquid products in the form of atomized sprays.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A liquid flow-focusing apparatus for droplet atomization is disclosed. The apparatus may include a dispensing body, including a liquid duct and a gas duct defined therein. The apparatus may include a plurality of nozzle wells defined in the dispensing body. The apparatus may include a plurality of flow-focusing nozzle inserts. Each nozzle well of the plurality of nozzle wells may be shaped to house a flow-focusing nozzle insert of the plurality of flow-focusing nozzle inserts. Each flow-focusing nozzle insert of the plurality of flow-focusing nozzle inserts may be housed in a corresponding nozzle well of the plurality of nozzle wells. Each flow-focusing nozzle insert of the plurality of flow-focusing nozzle inserts may be in fluid communication with the liquid duct and the gas duct.

A method of atomizing a liquid substance is disclosed. The method may include providing a liquid to a liquid duct in a dispensing body. The method may include providing a gas to a plurality of gas ducts in the dispensing body. The method may include introducing the liquid into a plurality of nozzle bodies via a plurality of liquid supply channels, each liquid supply channel of the plurality of liquid supply channels having a liquid supply channel exit opening. The method may include introducing the gas into a plurality of pressure chambers, each of the pressure chambers being defined by a pressure cap positioned outwardly proximate a nozzle body of the plurality of nozzle bodies. The method may include expelling the gas through a plurality of pressure chamber exit orifices positioned proximate the plurality of liquid supply channel exit openings. The method may include dispensing the liquid from the plurality of liquid supply channel exit openings and through the plurality of pressure chamber exit orifices such that the liquid and the gas interact and form atomized droplets of the liquid.

A liquid flow-focusing apparatus for droplet atomization is disclosed. The apparatus may include a dispensing body. The dispensing body may include an elongated cylindrical shape, a liquid duct defined in and traveling through a length of the dispending body, and a plurality of gas ducts defined in and traveling through a length of the dispending body. The apparatus may include a plurality of nozzle wells defined in the dispensing body and a plurality of flow-focusing nozzle inserts. Each flow-focusing nozzle insert may include a nozzle body having a liquid supply channel, wherein the liquid supply channel has a liquid supply channel exit opening, a pressure cap located outwardly proximate of the nozzle body and having an interior pressure cap end wall and a pressure cap exit orifice, and a plurality of O-rings, wherein the interior pressure cap end wall and nozzle body define a pressure chamber such that gas passes from the plurality of gas ducts to the pressure cap exit orifice through the pressure chamber. Each nozzle well of the plurality of nozzle wells may be shaped to house a flow-focusing nozzle insert of the plurality of flow-focusing nozzle inserts. Each flow-focusing nozzle insert of the plurality of flow-focusing nozzle inserts may be housed in a corresponding nozzle well of the plurality of nozzle wells.

Numerous other objects, advantages and features of the present disclosure will be readily apparent to those of skill in the art upon a review of the drawings and description of a preferred embodiment.

### BRIEF DESCRIPTION OF THE DRAWINGS

FIG. 1 is a front view of an exemplary embodiment of a liquid flow-focusing apparatus with an exemplary holder sleeve and exemplary gas and liquid connection lines.

FIG. 2 is a sectional front view of an exemplary embodiment of a liquid flow-focusing apparatus with an exemplary holder sleeve and exemplary gas and liquid connection lines.

FIG. 3 is a perspective view of an exemplary embodiment of a liquid flow-focusing apparatus with an exemplary holder sleeve.

FIG. 4 is a sectional front view of an exemplary embodiment of a liquid flow-focusing apparatus with an exemplary holder sleeve.

FIG. 5 is a sectional perspective view of an exemplary embodiment of a liquid flow-focusing apparatus.

FIGS. 6A and 6B are perspective views of an exemplary embodiment of a flow-focusing nozzle insert.

FIGS. 7A and 7B are perspective views of an exemplary embodiment of a pressure cap of a flow-focusing nozzle insert.

FIGS. 8A and 8B are perspective views of an exemplary nozzle body of a flow-focusing nozzle insert.

FIGS. 9A and 9B are perspective views depicting exemplary embodiments of O-rings of an exemplary flow-focusing nozzle insert.

FIG. 10 is a sectional side view of an exemplary embodiment of a flow-focusing nozzle insert.

FIG. 11 is a close up sectional side view of an exemplary embodiment of a flow-focusing nozzle insert.

FIGS. 12A and 12B are sectional side views depicting exemplary embodiments of a liquid flow-focusing apparatus mounted on an exemplary seed treater, wherein the outward liquid flow trajectories from the flow-focusing nozzle inserts are shown when the flow-focusing nozzle inserts are oriented on a 10 and 25 degree angle, respectively.

FIGS. 13A and 13B depict a side view and a front view of an exemplary embodiment of a dual reservoir pressurized liquid delivery system that supports an exemplary embodiment of a liquid flow-focusing apparatus.

FIGS. 14A, 14B, and 14C contain three different tables showing how liquid spray patterns (i.e., particle size distribution, d50) for three different liquids can be influenced by varying the gas flow and gas pressure being provided to an exemplary dispensing body.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use

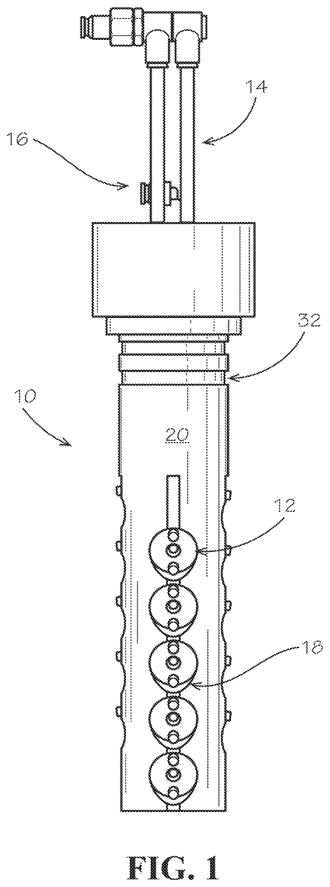

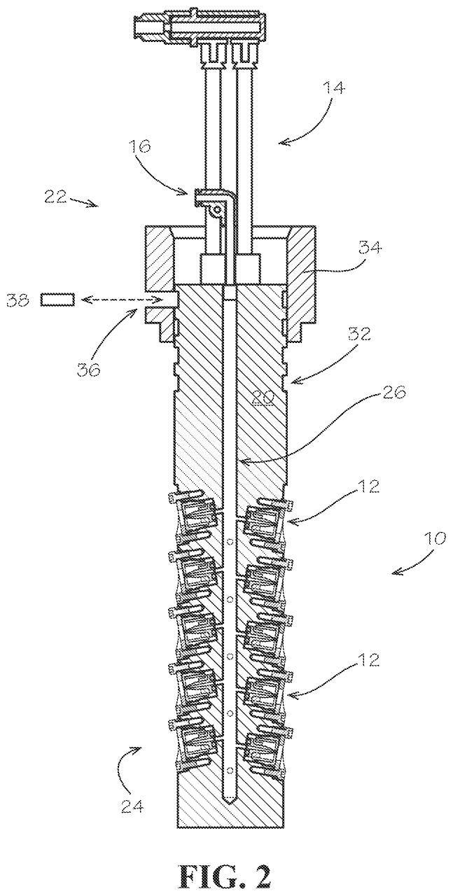

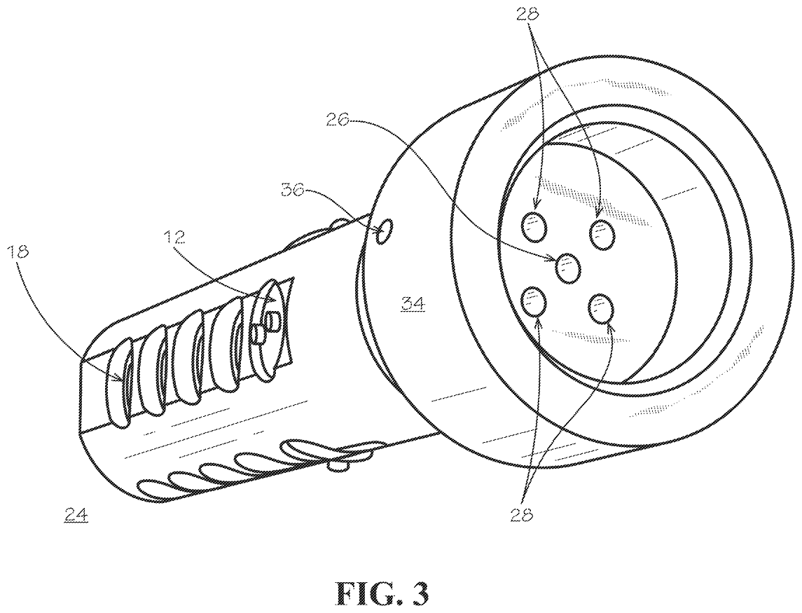

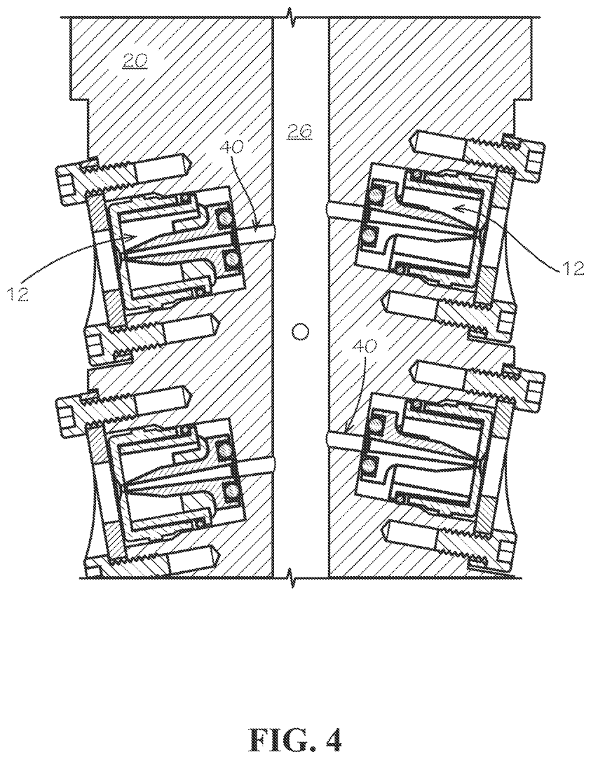

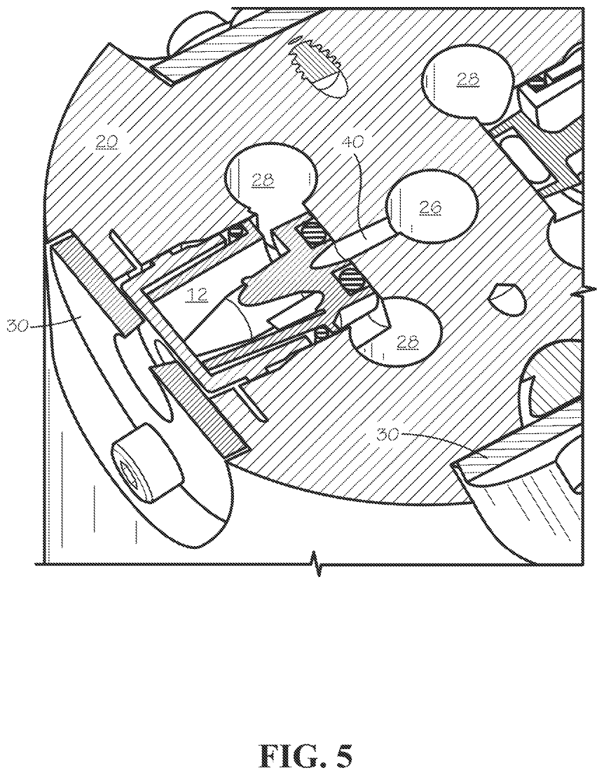

FIG. 1 illustrates one embodiment of an exemplary liquid flow-focusing apparatus 10. The apparatus 10 may generally provide for droplet atomization. Liquids may be atomized by the liquid flow-focusing apparatus 10 in order to break up a liquid substance while dispensing the liquid onto a surface. The liquid flow-focusing apparatus 10 may include a dispensing body 20. The dispensing body 20 may include a liquid duct 26 or one or more gas ducts 28 (not depicted in FIG. 1, but depicted in FIGS. 2-5). The apparatus 10 may include a plurality of flow-focusing nozzle inserts 12. The apparatus 10 may include a plurality of nozzle wells 18.

In some embodiments, the plurality of nozzle wells 18 may be formed along the dispensing body 20. One or more nozzle wells 18 of the plurality of nozzle wells 18 may be configured or shaped to house a flow-focusing nozzle insert 12 of the plurality of flow-focusing nozzle inserts 12. One or more flow-focusing nozzle inserts 12 may be housed in a corresponding nozzle well 18. Further, one or more of the flow-focusing nozzle inserts 12 may be in fluid communication with a liquid duct 26 or a plurality of gas ducts 28 that may receive incoming liquid substance and gas from a liquid supply line 16 or a plurality of gas supply lines 14 respectively. The flow-focusing nozzle inserts 12 may be in fluid communication via the one or more of the nozzle wells 18 being in fluid communication with the liquid duct 26 or the plurality of gas ducts 28. The liquid substance and gas may travel through the dispensing body 20 of the liquid flow-focusing apparatus 10 via a liquid duct 26 and a plurality of gas ducts 28 and pass out of the dispensing body 20 through the flow-focusing nozzle inserts 12 such that the liquid substance exits the liquid flow-focusing apparatus 10 as fine particles (atomized).

In some embodiments, the dispensing body 20 may be made from a metal material, such as aluminum, steel, or any other metallic material capable of being formed. In certain embodiments, the dispensing body 20 may be made from another type of rigid material capable of being formed. The dispensing body 20 may generally include an elongated shape.

Now referring to FIGS. 2-5, a liquid flow-focusing apparatus 10 is provided in greater detail. In one embodiment, the liquid flow-focusing apparatus 10 may include a dispensing body 20 having a receiving end 22, a distal end 24, a liquid duct 26, or a plurality of gas ducts 28. The liquid duct 26 or the plurality of gas ducts 28 may be defined as circular holes running through the length of the dispensing body 20. In some embodiments, the liquid duct 26 or the plurality of gas ducts 28 may begin at the receiving end 22 and travel downwards through the length of the dispensing body 20 to a location just short of the distal end 24. In an exemplary embodiment, each of the liquid duct 26 and plurality of gas ducts 28 may measure approximately 9 inches in length.

In one embodiment, the dispensing body 20 may be cylindrically shaped. The dispensing body 20 may include one liquid duct 26 and four gas ducts 28. In such an embodiment, the single liquid duct 26 may run along the center of the cylindrically shaped dispensing body 20 and may act as the main liquid feed line for each of the flow-focusing nozzle inserts 12. Further, each of the four gas ducts 28 may be positioned on a 0.848 inch diameter bolt circle. Each of the four gas ducts 28 may be located 45° relative to the central (X,Y) axis and may act as main gas feed lines. In one embodiment, the dispensing body 20 of the liquid flow-focusing apparatus 10 may contain a total of twenty nozzle wells 18 positioned in four rows of five nozzle wells 18 with each row angled 90° relative to each other. Each of the plurality of nozzle wells 18 may include a counterbore shaped therein for seating and retaining a nozzle insert retainer washer 30.

In one embodiment, one or more nozzle wells 18 of the plurality of nozzle wells 18 may further include a circular hole 40 defined therein. The circular hole 40 may run through the dispensing body 20 and may connect to the liquid duct 26. In some embodiments, liquid substance can flow via the circular hole 40 from the liquid duct 26 to one or more nozzle wells 18 of the plurality of nozzle wells 18 and one or more flow-focusing nozzle inserts 12 the plurality of flow-focusing nozzle inserts 12 housed therein. Additionally, each nozzle well 18 of the plurality of nozzle wells 18 may intersect multiple gas ducts that run through dispensing body 20. In some embodiments, a nozzle well 18 may intersect two out of four gas ducts 28. The intersection of a nozzle well 18 with at least one gas duct 28 may enable gas to be supplied to one or more nozzle wells 18 of the plurality of nozzle wells 18 and the one or more flow-focusing nozzle inserts 12 housed therein.

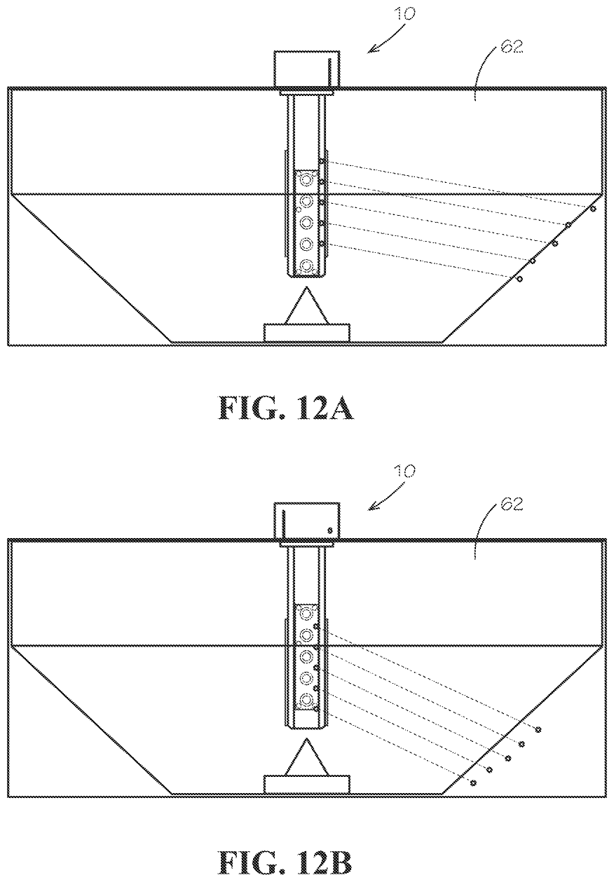

In some embodiments, the dispensing body 20 may include a plurality of recesses 32. The plurality of recesses 32 may be axially spaced along exterior portions of the dispensing body 20. In some embodiments, the plurality of recesses 32 may be particularly located near the receiving end 22 of the dispensing body 20. In some embodiments, the plurality of recesses 32 may be capable of engaging with a treater adapter 34 component or acting as a height adjuster in conjunction with a treater adapter 34 component in a seed-treater apparatus (for example, the seed-treater apparatus 62 of FIGS. 12A and 12B, discussed below). The treater adapter 34 can be configured to slide over and receive the receiving end 22 of the dispensing body 20. The treater adapter 34 may be retained in a permanent or semi-permanent position on various assemblies, including a seed-treater apparatus 62. As can be seen in FIG. 2, the treater adapter 34 may have a channel 36 shaped therein to receive a set fastener 38 that is capable of selectively retaining the dispensing body 20 in the treater adapter 34 at an adjustable position via one of the recesses 32. The set fastener 38 may include a screw such that when the set fastener 38 is advanced through the treater adapter 34, the set fastener 38 mechanically interferes with the sidewalls of the recesses 32 and prevents the advance or retreat of the dispensing body 20 relative to the treater adapter 34. In some embodiments, the treater adapter 34 may be made from a metal material, such as aluminum, steel, or any other metallic material capable of being formed.

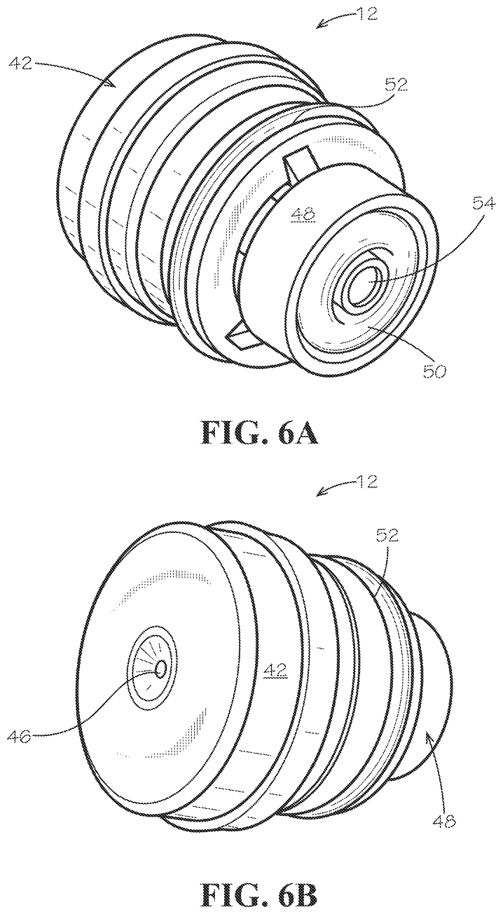

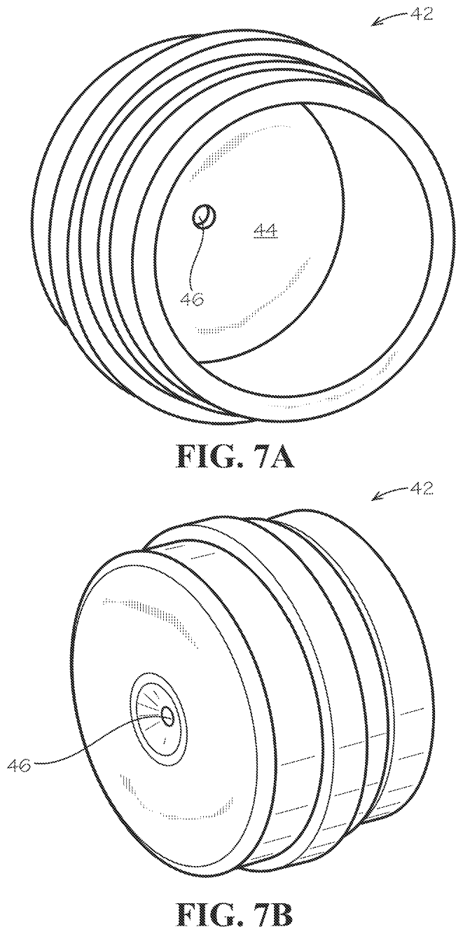

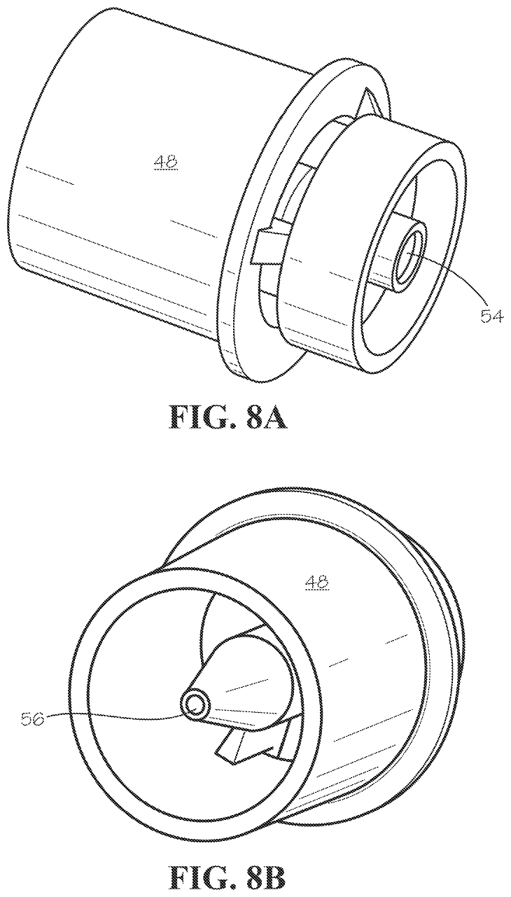

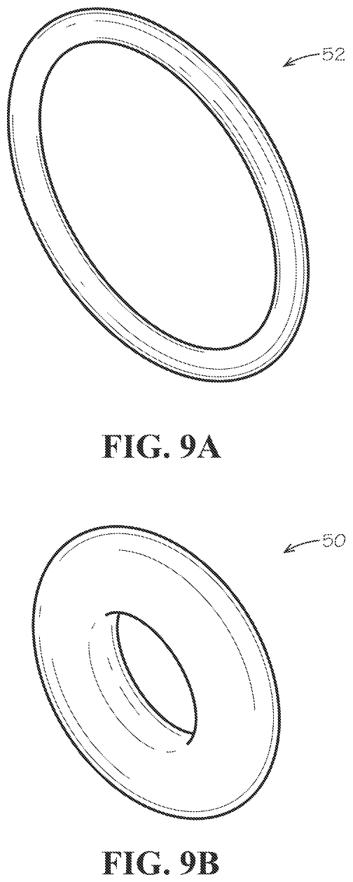

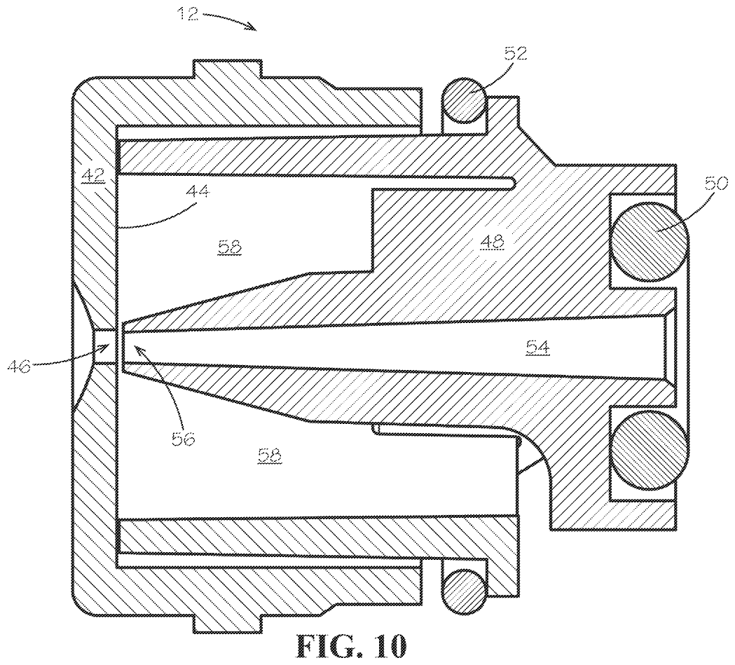

Referring now generally to FIGS. 6-11, different views of an embodiment of a flow-focusing nozzle insert 12, along with one or more of its possible sub-components, are shown. In one embodiment, the flow-focusing nozzle insert 12 may comprise a pressure cap 42, a nozzle body 48, or one or more O-rings 50 and 52. The O-rings 50, 52 may be different sizes from each other. The pressure cap 42 may further includes an interior pressure cap end wall 44 or a pressure cap exit orifice 46. The nozzle body 48 may further include a liquid supply channel 54 defined therein. The liquid supply channel 54 may include a liquid supply channel exit opening 56. Further, the interior pressure cap end wall 44 and nozzle body 48 may define a pressure chamber 58. The first O-ring 50 may be provided in order to maintain an air-tight seal between the liquid supply channel 54 of the nozzle body 48 and the circular hole 40. The second O-ring 52 may be provided to maintain an air-tight seal between the pressure cap 42 and the nozzle body 48. Thus, in such an embodiment, a gas entering the pressure chamber 58 from the gas ducts 28 may only be exhausted through the pressure cap exit orifice 46.

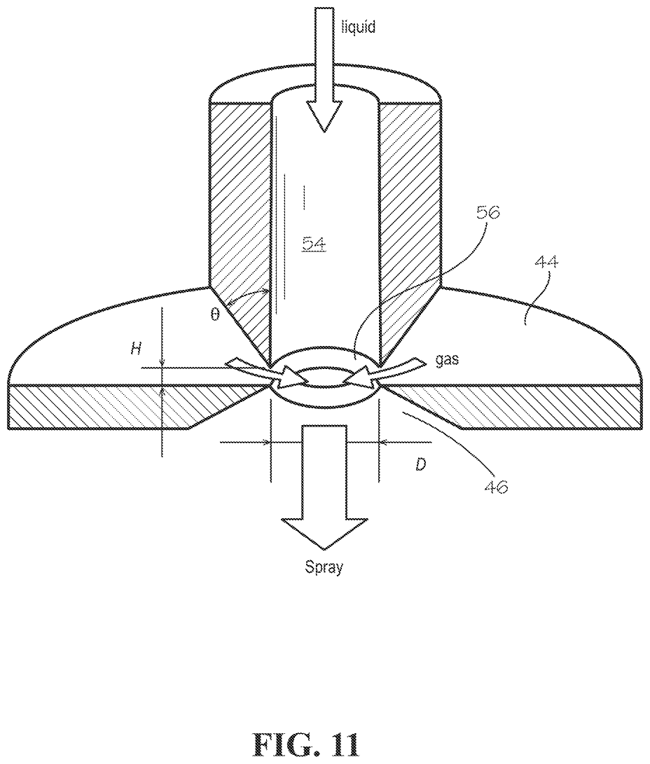

Regarding FIG. 11, in some embodiments, the pressure chamber 58 may narrow proximate the pressure cap exit orifices 46 and the liquid supply channel exit openings 56. The pressure chamber 58 may narrow to a distance of H, as seen in FIG. 11, between the interior pressure cap end wall 44 and the liquid supply channel exit opening 56. This may mean that the interior pressure cap end wall 44 is axially offset from the liquid supply channel exit opening 56 by a distance H. The distance H may be one of the factors that provides the proper physical interaction of the liquid substance and the gas to create various discharge patterns including flow-focusing and flow blurring. For example, the pressure cap exit orifice 46 may include a pressure cap exit orifice diameter D. In some embodiments, the flow-focusing nozzle insert 12 includes a ratio of H divided by D that is greater than about 0.25. In various other embodiments, the nozzle inserts 12 include a ratio of H divided by D of greater than 0.40. The ratio between H and D may promote certain interactions between the liquid substance and gas that may result in various spray patterns such as flow focusing and flow blurring.

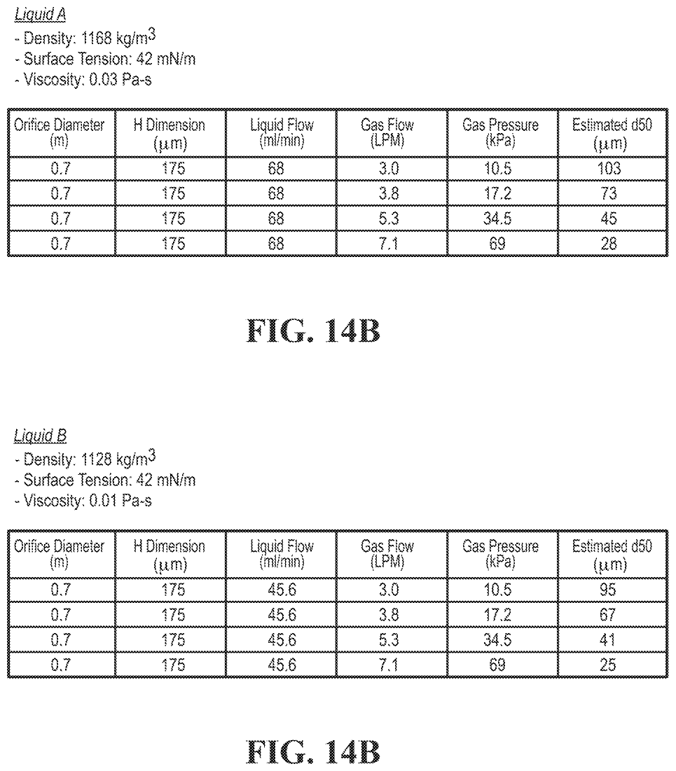

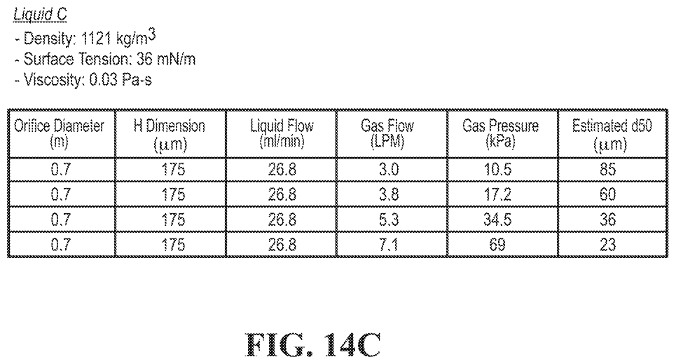

In some embodiments, the ratios between H and D can be adjusted such that one or more nozzle inserts 12 of the plurality of nozzle inserts 12 may produce a flow-focusing spray pattern. In other embodiments, H and D can be adjusted such that one or more nozzle inserts 12 produce a flow-blurring spray pattern. Yet, in some other embodiments, H and D can be adjusted to different values for one or more nozzle inserts 12 such that some nozzle inserts 12 produce a flow-focusing spray pattern while the other nozzle inserts 12 produce a flow blurring spray pattern. In such an embodiment, the apparatus 10 may simultaneously produce both a flow-focusing and a flow-blurring spray pattern. FIGS. 14A, 14B, and 14C provide three different tables showing how liquid spray patterns (i.e., particle size distribution, d50) for three different liquids can be influenced by varying the gas flow and gas pressure being provided to dispensing body 20.

In an example of how an outward liquid spray may be accomplished, a liquid substance may travel through the liquid duct 26, enter the liquid supply channel 54 via a circular hole 40, and travel through the liquid supply channel 54 and out the liquid supply channel exit opening 56. A gas may simultaneously travel through one or more gas ducts 38 and into the pressure chamber 58. As the gas moves through pressure chamber 58, the gas may exit the pressure cap exit orifice 46. The liquid substance traveling through the liquid supply channel 54 and out through both the liquid supply channel exit opening 56 and the pressure cap exit orifice 46 may be disrupted by the gas flowing out. Thus, the liquid substance may be broken up into small droplets.

In both flow focusing and flow blurring, the interactions may occur at one or more pressure cap exit orifices 46 of the plurality of pressure cap exit orifices 46 and one or more liquid supply channel exit openings 56. Thus, the liquid flow-focusing apparatus 10 may provide atomized liquid substance in 360 degrees around each of the plurality of nozzle inserts 12.

Referring to FIGS. 12A and 12B, the liquid flow-focusing apparatus 10 may be mounted to a seed-treater apparatus 62. The liquid flow-focusing apparatus 10 may be operable to have an adjustable spray distance via the treater adapter 34 and the set fastener 38. In some embodiments, the liquid flow-focusing apparatus 10 may be configured to have a total of four rows of five nozzle wells 18, each row of five nozzle wells 18 located 90 degrees relative to the other rows. In such embodiments, two of the four rows of five nozzle wells 18 may be positioned 180 degrees apart and oriented on a 10 degree angle while the other two rows of five nozzle wells 18 are positioned 180 degrees apart and oriented on a 25 degree angle. Each of the four rows may be angled as such to directly affect the direction of the liquid flow coming outwards from the flow-focusing nozzle inserts 12.

Now, one more exemplary embodiment of the liquid flow-focusing apparatus 10 will now be described in particular detail. In this exemplary embodiment, the dispensing body 20 of liquid flow-focusing apparatus 10 may include an aluminum (e.g., 6061 T6 grade) cylinder configuration. The overall dimension of the dispensing body 20 may include a 2 inch diameter and a 9.5 inch length. The dispensing body 20 may include two 0.75 inch wide flats by 6 inches long (from bottom surface) located 180° apart to aid in fabrication. In this exemplary embodiment, the dispensing body 20 may include a 15/64 inch diameter by 9 inch deep hole (from top surface) located in the center of the cylinder which may act as a main liquid duct 26. Further, the dispensing body 20 may include four 15/64 inch diameter by 9 inch deep holes (from top surface) positioned on a 0.848 inch diameter bolt circle. Each hole may be located 45° relative the (X,Y) axis, which may act as the main gas ducts 28. The dispensing body 20 may include four 0.260 inch wide by 1/16 inch deep recesses 32 positioned near the receiving end 22, which may act as a height-adjuster in conjunction with a treater adapter 34 component in the seed-treater apparatus 62.

In this embodiment, the dispensing body 20 may include twenty atomizing nozzle wells 18 measuring 0.510 inches in diameter each and a secondary diameter of 0.450 inches, which may relate to the profile of a nozzle insert 12. The twenty nozzle wells 18 are positioned in four rows of five with each row 90° relative to each other. Two rows of nozzle wells 18 (ten total nozzle wells), positioned 180° apart, may be oriented on a 10° angle to directly affect the direction of liquid flow. Two rows of nozzle wells 18 (ten total nozzle wells), positioned 180° apart, may be oriented on a 25° angle to directly affect the direction of liquid flow. Each nozzle well 18 may include a counterbore measuring 0.9 inches in diameter for seating a nozzle insert retainer washer 30. Each nozzle well 18 counterbore may include two 4-40 UNC tapped holes to retain the nozzle insert retainer washer 30. Each nozzle well 18 may include two 3/16 inch wide slots which may be intended to aid in extracting nozzle inserts 12.

In this embodiment, each nozzle well 18 may intersect two of the four 15/64 inch diameter gas (compressed air) ducts 28, which is how the gas is delivered to the nozzle inserts 12. Further, each nozzle well 18 may include a 0.067 inch diameter hole that may intersect the 15/64 inch diameter liquid duct 26, which is how the liquid is delivered to the nozzle inserts 12. In this exemplary embodiment, the material of the retainer washer 30 may include one or more of a variety of materials. The physical size of the twenty nozzle insert retainer washers 30 may include a ⅞ inch diameter and may be 5/64 inches thick. Further, each nozzle insert retainer washer 30 may include a 17/64 inch diameter thru clearance which allows the atomized liquid to pass. Furthermore, there can be two ⅛ inch diameter screw clearance holes which may facilitate mounting each nozzle insert retainer washer 30 to the dispensing body 20.

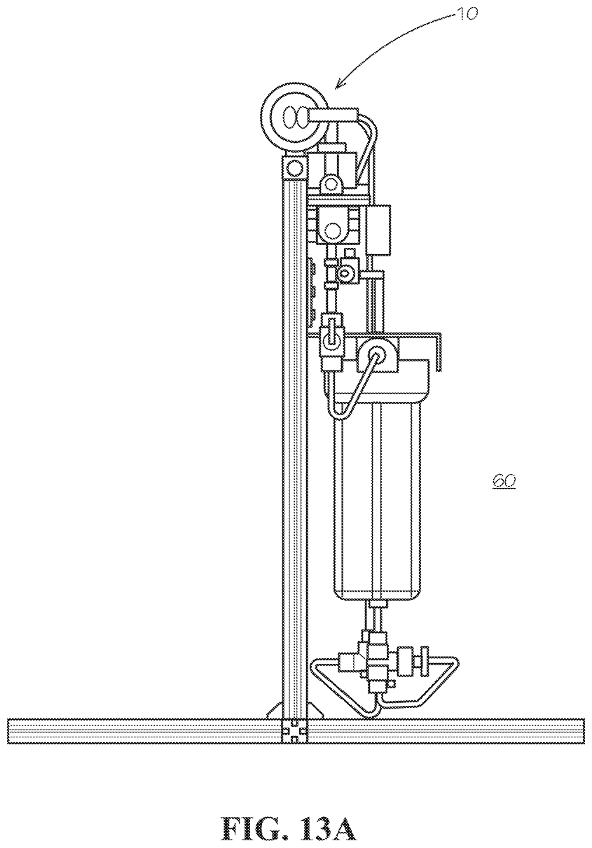

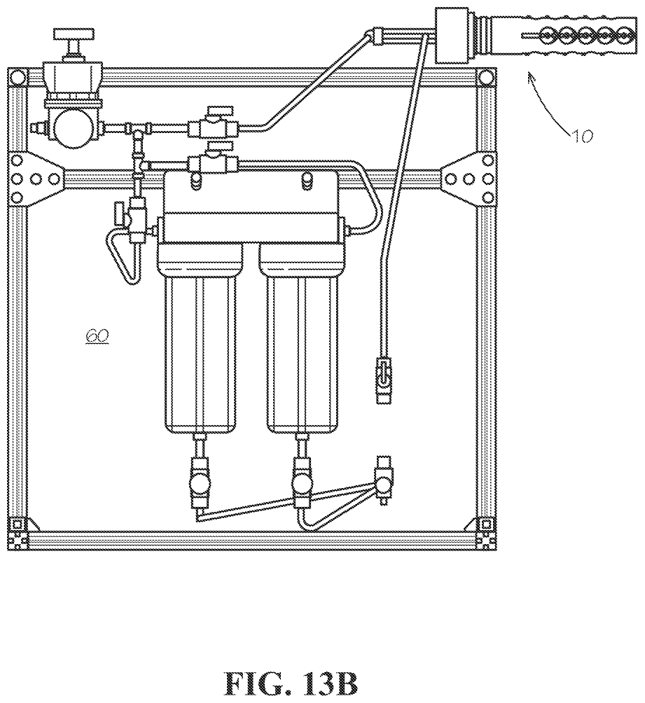

This exemplary embodiment may be able to interface with a treater adapter 34, which may include aluminum (e.g., 6061 T6 grade). The treater adapter 34 component may include a sleeve configuration which may include a primary purpose of holding the dispensing body 20 in a desired position in the seed-treating apparatus 62. In such an exemplary embodiment, the overall size of the treater adapter 34 may include a diameter of 3 inches and a length of 2 inches. Further, the treater adapter 34 may include an inside diameter of 2.010 inches, which may fit appropriately over the outside diameter of the dispensing body 20. The treater adapter 34 may include a ¼-20 UNC tapped hole 36 through the cylinder wall, which may accommodate a set screw/fastener 38. The set screw 38 of treater adapter 34 may be intended to engage one of the four recesses 32 of the dispensing body 20 to adjust the height inside the seed-treater apparatus 62. In this exemplary embodiment, the flow-focusing nozzle insert 12 may include a subassembly that may include a nozzle body 48, a nozzle pressure cap 42, and two O-rings 50 and 52. The nozzle body 48 may have an “H” dimension to create a flow-focusing liquid dispensing profile. Furthermore, a dual reservoir pressurized liquid delivery system 60, such as the one depicted in FIGS. 13A and 13B, may be additionally provided to support the exemplary embodiment of the liquid flow-focusing apparatus 10 described immediately above as well as other embodiments of the same.

A method of atomizing a liquid substance is also disclosed. The method may include providing a liquid to a liquid duct 26 in a dispensing body 20. The method may include providing a gas to a plurality of gas ducts 28 in the dispensing body 20. The method may include introducing the liquid into a plurality of nozzle bodies 48 via a plurality of liquid supply channels 54, each liquid supply channel 54 of the plurality of liquid supply channels 54 having a liquid supply channel exit opening 56. The method may include introducing the gas into a plurality of pressure chambers 58, each of the pressure chambers 58 being defined by a pressure cap 42 positioned outwardly proximate a nozzle body 48 of the plurality of nozzle bodies 48. The method may include expelling the gas through a plurality of pressure chamber exit orifices 46 positioned proximate the plurality of liquid supply channel exit openings 56. The method may include dispensing the liquid from the plurality of liquid supply channel exit openings 56 and through the plurality of pressure chamber exit orifices 456 such that the liquid and the gas interact and form atomized droplets of the liquid.

In some embodiments, the pressure cap 42 may include an interior pressure cap end wall 44. The interior pressure cap end wall 44 may be axially offset from the liquid supply channel exit opening 56 by a distance H. Each pressure chamber exit orifice 46 may include a diameter D. The ratio of the distance H divided by the diameter D may be greater than about 0.25. In one embodiment, the method may further include adjusting the ratio to a first ratio, thereby producing a flow-focusing spray pattern. The method may include adjusting the ratio to a second ratio, thereby producing a flow-blurring spray pattern.

In certain embodiments, the method may further include engaging the dispensing body 20 with a treater adapter 34 component of a seed-treater apparatus 62. In one or more embodiments, providing the gas to the plurality of gas ducts 28 may include providing compressed air to the plurality of gas ducts 28. In one embodiment, the method may include one or more actions discussed herein in relation to the apparatus 10.

Thus, although there have been described particular embodiments of the present invention of a new and useful liquid flow-focusing apparatus, it is not intended that such references be construed as limitations upon the scope of this invention. It must be understood herein that all device materials, dimensions, scale, nozzle counts, etc. can be modified to accommodate various applications while maintaining the design intent.

What is claimed is:

1. A liquid flow-focusing apparatus for droplet atomization, comprising:
a dispensing body, including a liquid duct and a gas duct defined therein;
a plurality of nozzle wells defined in the dispensing body; and
a plurality of flow-focusing nozzle inserts, wherein
each nozzle well of the plurality of nozzle wells is shaped to house a flow-focusing nozzle insert of the plurality of flow-focusing nozzle inserts,
each flow-focusing nozzle insert of the plurality of flow-focusing nozzle inserts is housed in a corresponding nozzle well of the plurality of nozzle wells, and
each flow-focusing nozzle insert of the plurality of flow-focusing nozzle inserts is in fluid communication with the liquid duct and the gas duct.

2. The liquid flow-focusing apparatus of claim 1, wherein:
the gas duct comprises a plurality of gas ducts; and
each flow-focusing nozzle insert of the plurality of flow-focusing nozzle inserts is in fluid communication with at least two gas ducts of the plurality of gas ducts.

3. The liquid flow-focusing apparatus of claim 2, wherein the plurality of gas ducts comprises four gas ducts.

4. The liquid flow-focusing apparatus of claim 1, wherein each flow-focusing nozzle insert of the plurality of flow-focusing nozzle inserts is secured to the dispensing body by a nozzle insert retainer washer.

5. The liquid flow-focusing apparatus of claim 1, wherein the number of nozzle wells of the plurality of nozzle wells equals the number of flow-focusing nozzle inserts of the plurality of flow-focusing nozzle inserts.

6. The liquid flow-focusing apparatus of claim 1, wherein the plurality of nozzle wells are disposed in a plurality of rows on the dispensing body.

7. The liquid flow-focusing apparatus of claim 1, wherein each flow-focusing nozzle insert of the plurality of flow-focusing nozzle inserts comprises:
a nozzle body having a liquid supply channel, wherein the liquid supply channel has a liquid supply channel exit opening;
a pressure cap located outwardly proximate of the nozzle body and having an interior pressure cap end wall and a pressure cap exit orifice; and
a plurality of O-rings,
wherein the interior pressure cap end wall and the nozzle body define a pressure chamber such that gas passes from the gas duct to the pressure cap exit orifice through the pressure chamber.

8. The liquid flow-focusing apparatus of claim 7, wherein:
the pressure cap exit orifice includes an exit orifice diameter;
the interior pressure cap end wall is axially offset from the liquid supply channel exit opening by a distance; and
the ratio of the distance divided by the exit orifice diameter is greater than about 0.25.

9. The liquid flow-focusing apparatus of claim 8, wherein the ratio is adjustable.

10. The liquid flow-focusing apparatus of claim 9, wherein:
a nozzle insert of the plurality of nozzle inserts produces a flow-focusing spay pattern in response to a first ratio of the distance divided by the exit orifice diameter; and
the nozzle insert produces a flow-blurring spay pattern in response to a second ratio of the distance divided by the exit orifice diameter.

11. The liquid flow-focusing apparatus of claim 1, wherein the dispensing body is in fluid communication with a dual reservoir pressurized liquid delivery system.

12. The liquid flow-focusing apparatus of claim 1, wherein the dispensing body comprises a metallic material.

13. The liquid flow-focusing apparatus of claim 1, wherein the dispensing body comprises a cylindrical shape.

14. The liquid flow-focusing apparatus of claim 1, wherein:
the dispensing body comprises a plurality of recesses axially spaced along an exterior portion of the dispensing body; and
the plurality of recesses are configured to engage with a seed-treater apparatus.

15. A method of atomizing a liquid substance, comprising:
providing a liquid to a liquid duct in a dispensing body;
providing a gas to a plurality of gas ducts in the dispensing body;
introducing the liquid into a plurality of nozzle bodies via a plurality of liquid supply channels, each liquid supply channel of the plurality of liquid supply channels having a liquid supply channel exit opening;
introducing the gas into a plurality of pressure chambers, each of the pressure chambers being defined by a pressure cap positioned outwardly proximate a nozzle body of the plurality of nozzle bodies;
expelling the gas through a plurality of pressure chamber exit orifices positioned proximate the plurality of liquid supply channel exit openings; and
dispensing the liquid from the plurality of liquid supply channel exit openings and through the plurality of pressure chamber exit orifices such that the liquid and the gas interact and form atomized droplets of the liquid.

16. The method of claim 15, wherein:
the pressure cap includes an interior pressure cap end wall that is axially offset from the liquid supply channel exit opening of the plurality of liquid supply channel exit openings by a distance;
each pressure chamber exit orifice of the plurality of pressure chamber exit orifices includes a diameter; and
the ratio of the distance divided by the diameter is greater than about 0.25.

17. The method of claim 16, further comprising:
adjusting the ratio to a first ratio, thereby producing a flow-focusing spray pattern; and
adjusting the ratio to a second ratio, thereby producing a flow-blurring spray pattern.

18. The method of claim 15, further comprising engaging the dispensing body with a treater adapter component of a seed-treater apparatus.

19. The method of claim 15, wherein providing the gas to the plurality of gas ducts comprises providing compressed air to the plurality of gas ducts.

20. A liquid flow-focusing apparatus for droplet atomization, comprising:
a dispensing body, wherein the dispensing body includes
an elongated cylindrical shape,
a liquid duct defined in and traveling through a length of the dispending body, and
a plurality of gas ducts defined in and traveling through a length of the dispensing body;
a plurality of nozzle wells defined in the dispensing body; and
a plurality of flow-focusing nozzle inserts, wherein
each flow-focusing nozzle insert includes
a nozzle body having a liquid supply channel, wherein the liquid supply channel has a liquid supply channel exit opening,
a pressure cap located outwardly proximate of the nozzle body and having an interior pressure cap end wall and a pressure cap exit orifice, and
a plurality of O-rings, wherein the interior pressure cap end wall and the nozzle body define a pressure chamber such that gas passes from the plurality of gas ducts to the pressure cap exit orifice through the pressure chamber,
each nozzle well of the plurality of nozzle wells is shaped to house a flow-focusing nozzle insert of the plurality of flow-focusing nozzle inserts, and
each flow-focusing nozzle insert of the plurality of flow-focusing nozzle inserts is housed in a corresponding nozzle well of the plurality of nozzle wells.
